(19) United States
(12) Patent Application Publication
(10) Pub. No.: US 2016/0306955 A1
(43) Pub. Date: Oct. 20, 2016

(54) PERFORMING USER SEAMLESS AUTHENTICATIONS

(71) Applicant: Intel Corporation, Santa Clara, CA (US)

(72) Inventors: Jason Martin, Beaverton, OR (US); Rahuldeva Ghosh, Portland, OR (US); Cory Cornelius, Portland, OR (US); Ian R. Oliver, Portland, OR (US); Ramune Nagisetty, Portland, OR (US); Steven B. McGowan, Portland, OR (US)

(21) Appl. No.: 14/859,611

(22) Filed: Sep. 21, 2015

Related U.S. Application Data
(60) Provisional application No. 62/147,080, filed on Apr. 14, 2015.

(51) Int. Cl. G06F 21/34; G06F 21/35

(52) U.S. Cl. CPC G06F 21/34; G06F 21/35

(57) ABSTRACT

In one embodiment, a first device includes: a first logic to generate a first token when a user adapts the first device in approximate contact to the user, the first token including a first timestamp; a storage to store the first token and a second token, the second token obtained from an authenticator and associated with an authentication of the user to a second device, the second token including a second timestamp; and a communication module to communicate the first and second tokens to the second device to cause the second device to authenticate the user based at least in part on the first and second tokens. Other embodiments are described and claimed.

This application claims priority to U.S. Provisional Patent Application No. 62/147,080 filed on Apr. 14, 2015, in the names of Jason Martin, Rahuldeva Ghosh, Cory Cornelius, Ian R. Oliver, Ramune Nagisetty and Steven B. McGowan, entitled PERFORMING USER SEAMLESS AUTHENTICATIONS, the disclosure of which is hereby incorporated by reference.

### TECHNICAL FIELD

The following relates to performing authentications using multiple devices.

### BACKGROUND

Strong user authentication to a computing system is often a tedious and difficult task for users to perform, requiring them to remember and type complex passwords, use unreliable biometrics, wait for and then type second-factor codes received from text messages, and so forth. At the same time, authentication demands on users are increasing with more systems and services requiring or encouraging multi-factor authentication and more frequent authentications. While such activities may increase security, it can affect user experience undesirably.

### BRIEF DESCRIPTION OF THE DRAWINGS

FIG. 1 illustrates some examples of form factors of embodiments of wearable devices.

FIG. 2 is flow diagram of a high level method of a user authentication in accordance with an embodiment of the present invention.

FIG. 3 is an illustration of fields of a token in accordance with an embodiment of the present invention.

FIG. 4 illustrates example components included in an embodiment of the wearable device.

FIG. 5 illustrates an embodiment of a protected device incorporating authentication technology consistent with the present disclosure.

FIG. 6 is a block diagram of a network architecture in accordance with an embodiment of the present invention.

FIG. 7 is a block diagram of a wearable module in accordance with another embodiment.

FIG. 8 illustrates another system to perform proximity-based authentications as described herein.

FIG. 9 is a flow diagram of a method in accordance with an embodiment.

### DETAILED DESCRIPTION

In various embodiments, multiple devices may participate in a user authentication using one or more tokens to provide a mechanism to securely represent multi-factor authentication information, allowing a device (such as a wearable device) that provides a technical guarantee that its tokens represent historical multi-factor authentication and context information with the same or similar strength to an original authentication of the user, reducing user burden. Based on these tokens, which may represent time, proximity, user actions, or so forth recorded by one device, another device may use such tokens to securely make authentication decisions.

By providing a given authentication service in accordance with an embodiment, a device which a user has in close proximity to the user can securely represent authentication decisions to other devices. Such device can also securely represent historical authentication context for later re-use by other devices to improve user experience. Although the scope of the present invention is not so limited, such context can take the form of registration information, authentication tokens, and on-body or human presence tokens (also referred to herein as a proximity token). In general, a “proximity token” or “on-body token” may be used in a given authentication scheme to indicate whether a user is wearing (and/or is in close proximity to) the device.

In an embodiment, this context can be stored in a database (potentially stored locally in a user device or remotely in a storage of a cloud identity provider) in a manner to allow sharing and synchronization to authentication policy enforcement endpoints. In various embodiments, security requirements may be enforced, while minimizing the negative user experience impact of authentication as much as possible. Embodiments may be applicable to a variety of different devices and use cases, and modes, such as a wide variety of different user authentication systems. Some examples are for use with a passive device such as a wireless-capable device (e.g., a Bluetooth low energy (BLE)) device that does not support on-device authentication. Other examples are for use with an active device such as a wireless-capable device that supports on-device authentication.

A wearable device is used to represent a strong or multi-factor authentication of the user and the current presence of the user for the duration that the device is worn. The basic model involves the user putting the device on and then performing a strong or multi-factor authentication through a second device which may have been paired to the wearable device, or may be enrolled in an identity service which has been paired to the wearable device. Note that as such, embodiments are not limited to device-to-device pairing. For example, a wearable device can be paired with a cloud or enterprise service, which would then allow the user to use the wearable with any nearby device that is enrolled with that service. Such embodiments may be applicable for enterprise deployment and consumer deployment across many devices.

In many cases, an identity solution may first determine that the wearable device is in close proximity to one or more primary factors of authentication before generating tokens and storing them in the wearable device. For example, the wearable can be located very close to a fingerprint reader before a fingerprint token is generated and placed on the wearable, to prevent someone else from wearing the wearable and obtaining a token from the user. In such example, a signal strength distance bounding can be used to determine proximity between the wearable and the authentication factor (e.g., a smartphone or computer having a fingerprint reader).

For a given duration (e.g., a remainder of the day) the wearable device is used to present that multi-factor authentication and the presence of the user who performed that authentication to the second device and to other devices within the user's continuum of devices.

The wearable device may have the ability to store one or more tokens that represent the user's authentication and securely present such token(s) on demand to one or more paired devices. The wearable device may have the ability to detect when the device has been removed from the user (e.g., a sensor that detects loss of contact with skin), at which point the stored token can be invalidated (or even discarded) such that the user would have to re-perform the authentication task to make further use of the paired device. The wearable device may have the ability to provide a presence indicator to a paired device so that the paired device knows when the wearable device is near.

The wearable device may also include its own sensors to provide supplementary or primary authentication and presence factors that can be used as part of the initial strong authentication and/or as part of the ongoing detection that the device is still being worn by the user (e.g., the wearable device could monitor the EKG of the user to verify the device is still connected to the same user).

In many embodiments, the resulting strong authentication (e.g., biometric-based authentication), which may include any one or more biometric authentication techniques such as a fingerprint scanner authentication, a palm reader authentication, iris scanner authentication, or any one or more of other types of biometric identification techniques, may be stored as one or more tokens in the wearable device. In an embodiment, the wearable device includes this token storage along with a dead man switch. The dead man switch includes logic that requires the user to have the wearable device on (in contact with the user) or in approximate contact with the user's body for the switch to stay active. As soon as the user removes the wearable device from contacting the user's body or the wearable device's battery is depleted, the token is removed or otherwise invalidated from the wearable device and the strong biometric authentication may be performed again.

“Approximate contact” may mean direct contact with the skin, or separation from the skin by a small air gap on the order of a few centimeters or less (as with a pendant wearable device that may swing a small distance away from the skin when the user leans forward), or contact with a clothing material or accessory through which some index of a nearby human presence (e.g., breath, a heartbeat, a thermal or electromagnetic signature) can be sensed by one or more sensors in the wearable device. The dead man switch, when triggered by a sensor's failure to detect the user's continued presence, may activate logic that removes or otherwise disables the stored token, so that no unauthorized person may use the wearable device to access one or more other devices. To resume authorized use of the wearable device, the authorized user performs a strong re-authentication process after putting the wearable device back on.

The dead man switch logic tells relying parties that the device is still attached to the user who performed the strong authentication in the first place. Essentially, this allows the wearable device to prove that the user who performed the strong authentication on another device at some earlier point in time is the same user who is now trying to access the current device. In some embodiments, the dead man switch may not be immediately triggered at the instant the sensors fail to detect continued contact with the user. The logic may include a built-in delay between the sensors' failure to detect user contact and the activation of the dead man switch. If the sensors resume sensing a user presence during the delay, the dead man switch is not activated. This prevents the dead man switch from being unnecessarily activated when the sensors lose contact with the user presence for a very short time; for example, if the wearable device swings, bounces, or twists when the user walks or changes position. Optionally, the delay time may be less than the time it would take for the user to remove the wearable device and for someone else to put on the user's wearable device. “Approximate contact” also includes this type of intermittent contact, with loss of contact lasting less than a threshold duration (e.g., on the order of seconds or less).

In addition, because the strong authentication can be done on one paired device and used on other devices, this enables strong authentication to be used on devices that do not have the physical ability to perform that same strong authentication. For example, palm vein authentication can be performed on a user's computer to securely access services on a phone later in the day when the computer with the palm vein authentication is not nearby (or vice versa).

Because the wearable device is in communication with the device being used by the user, it is a strong presence indicator that the same user is still interacting with the system and can be used to lock the system should the user with the wearable device step away (or the user takes off the wearable device). Biometric recognition along with continuous presence monitoring using a wearable device replaces passwords or augments them and is an even more secure, eloquent solution for next generation computing platforms.

In some embodiments, one or more first devices (primary protected devices) configured for at least one type of strong authentication provides initial authentication of all authorized users of primary or secondary protected devices, by biometric or other means. This may be repeated after periodic (e.g., daily or weekly) system resets. A primary protected device may be a computer, a laptop, a phone, a set-top box, a smart appliance, or any other type of device that would have at least one type of biometric reading mechanism.

In some embodiments, a second, wearable device is worn by the user in some manner. While the user wears the wearable device, the strong authentication can be performed at the primary protected device and the primary protected device can then send a secure token or key, representing the successful strong authentication of an authorized user, to the wearable device. The wearable device, after receiving the token or key from the primary protected device, may begin monitoring the continued presence of the user. At approximately the same time, or alternatively at a selected later time, the primary protected device transmits a copy of at least this token (and optionally a proximity token) over the network to other protected devices (or to a data store accessible to the other protected devices). The user wearing the wearable device may then automatically be authenticated into the other protected devices, including computing platforms of all types and services, that detect the token on the wearable device within a threshold proximity, compare it to each copy in the list of token copies transmitted by primary protected device(s), and find a match that verifies the token's validity. This threshold proximity may be set by a threshold signal strength of a short-range wireless signal such as BLE, Near Field Communication (NFC), or another type of proximity-based wireless technology. The wearable device token, or other wireless authentication functionality, may be disabled when (1) it is removed from the user's body, (2) if the battery or other power source is depleted, or (3) a scheduled reset of the authentication system occurs.

Embodiments thus reuse previous authentication events through the concept of authenticator-generated tokens and a device to securely provide such tokens at a later time along with evidence that the device has remained with the same user since the tokens were generated. This enables a variety of use cases as will be described herein, including passive re-authentication, starting an authentication session on one device and continuing the authentication session on a second device, and an enhanced user experience via, e.g., a once-per-day authentication. Embodiments also provide a standardized way for authenticator devices to produce tokens/assertions of the user in a way that simplifies implementation of identity services that consume such evidence.

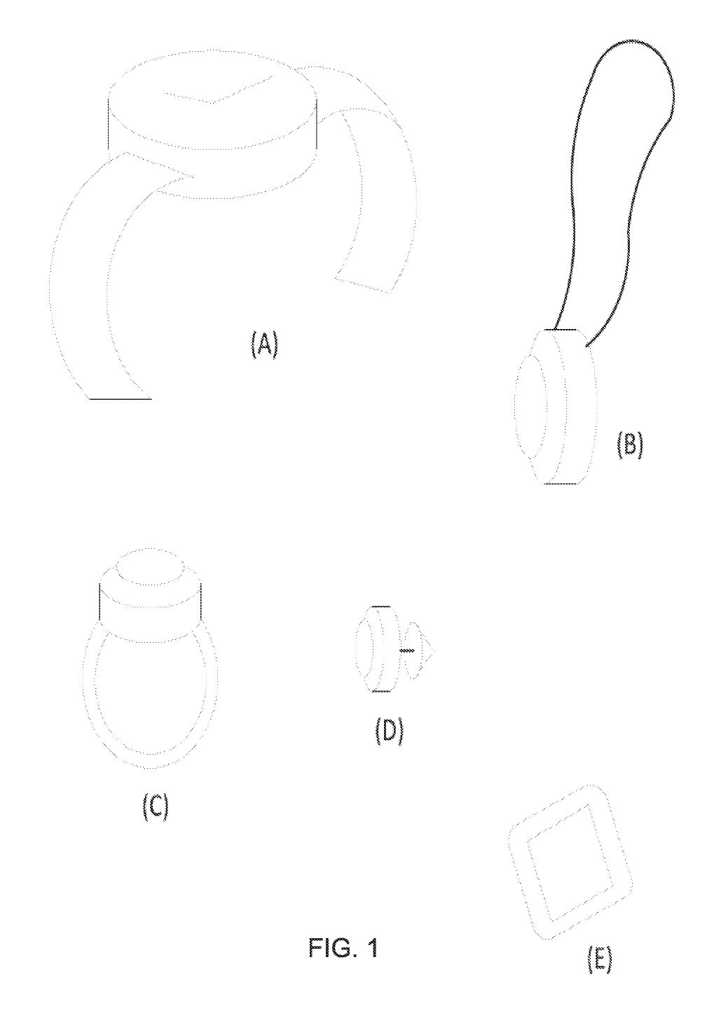

FIG. 1 illustrates many embodiments of potential wearable form factors of devices that may be implemented as the wearable companion device. In different embodiments, the wearable companion device that stores the strong authentication token may be a watch (A), a pendant (B), a ring (C), an earring (D), an adhesive skin patch (E), or one or more many other types of wearable devices that are able to maintain contact or approximate contact with the user.

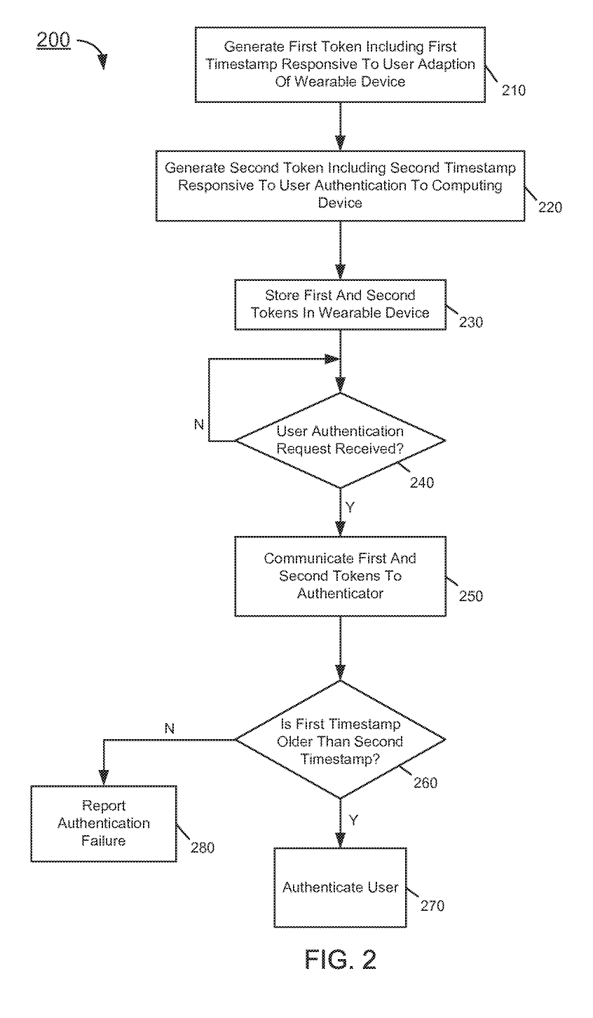

Referring now to FIG. 2, shown is flow diagram of a high level method of an authentication in accordance with an embodiment of the present invention. Method 200 may be performed by various combinations of hardware, software, and/or firmware, including hardware-based logic in one or more computing devices to enable creation of multiple tokens for use in initial and successive authentications of a user to one or more computing devices with minimal or no user involvement.

As shown, method 200 begins by generating a first token including a first timestamp (block 210). This first token may be generated responsive to user adaptation of a wearable device. As such, this first token may be generated, e.g., in the wearable device itself, when the user puts on the wearable device or otherwise places the wearable device in at least approximate contact. Note that the first timestamp included in this first token may be associated with the time at which the user puts on or otherwise adapts the wearable device. Next, control passes to block 220 where a second token is generated including a second timestamp. This second token generation may be responsive to a user authentication to a computing device, e.g., separate from the wearable device. This second timestamp may be associated with a time at which the user authentication occurs. For example, assume that the computing device is a smartphone, tablet computer, laptop computer, desktop computer or other computing platform that the user seeks to access. For purposes of discussion, assume that this second device is the user's work computer. Note that this token may be associated with a particular factor of authentication which can vary in different embodiments. As such, the strength and type of authentication can be part of the information stored in the token. Furthermore, understand that for the high level view shown in FIG. 2, only a single factor authentication is described. In many cases however the initial user authentication may be according to a multi-factor authentication such that a plurality of tokens can be generated in this user authentication.

Still with reference with to FIG. 2, control next passes to block 230 where these first and second tokens may be stored in the wearable device. In this embodiment described where the second token (at least) is generated in the separate computing device, a communication of this second token to the wearable device may occur to enable storage of this second token, along with the first token in a storage of the wearable device. In an embodiment, this storage may be a non-volatile storage that includes at least some amount of a secure storage such that the tokens may be stored and later accessed while the wearable device is in a trusted execution environment. Of course in other cases, the tokens may be encrypted or otherwise protected in another manner such that the storage and accessing can occur outside of a trusted execution environment.

Still with reference to FIG. 2, next it is determined whether a user authentication request is received (diamond 240). If so, control passes to block 250. Note that this user authentication request may be responsive to the user seeking to later access the same computing device or another device associated with the user, or responsive to a re-authentication time period elapsing. Responsive to this request, which may be received by the wearable device at block 250, the first and second tokens can be communicated to an authenticator or verifier. In the case where this user authentication request is for the user to access the computing device described above, the authenticator may be the computing device itself. In other usage models understand that the authenticator may be another device, including a remote authentication service of an identity provider such as accessible via the Internet.

Still referring to FIG. 2, at diamond 260 it is determined whether the first timestamp is older than the second timestamp. This determination, if successful, indicates that the user was wearing the wearable device prior to first authenticating to the computing device and has not removed the wearable device since that time. This may be ensured in various embodiments by causing the wearable device to delete or otherwise remove the tokens when the user removes or otherwise disassociates from the wearable device. In this or other cases, the disassociation of the user from the wearable device may otherwise be communicated to appropriate computing devices and/or authenticator. Also understand that this determination at diamond 260 may be according to a particular security policy and in other cases, such timestamp-based confirmation may not be required.

However for purposes of illustration in FIG. 2, if it is determined that the first timestamp is not older than the second timestamp, control passes to block 280 where an authentication failure may be reported. As such, the user may be prevented from access to the computing device or at least be prevented from access to secure information, such as preventing the user from entering into a secure session with the computing device. Otherwise if it is determined that the first timestamp is older than the second timestamp, control passes to block 270 where the user is authenticated and thus may access protected portions of the computing system and enter into a secure session. Understand while shown at this high level in the embodiment of FIG. 2 many variations and alternatives are possible.

In various embodiments, the contents of tokens allow a policy enforcement point to infer critical information about the trust state. Referring now to Table 1, shown is a list of example fields of a token in accordance with an embodiment. As seen, a variety of different types of metadata may be stored in the fields of a token. Also understand while these particular fields are shown in Table 1, many different types of information can be stored in other embodiments.

TABLE 1

| Field | Information |
|---|---|
| Version | Token format version number. |
| Issuer | Issuer of the token. |
| Authentication Factor | Authentication factor that created this token. |
| Authentication | Authentication confidence: |
| Confidence | 0 - None/Expired |
| | 1 - Low |
| | 2 - Medium |
| | 3 - High |
| TimeStamp | Timestamp when token was created by issuer. |
| Location | Where the original authentication represented |
| | by this token took place. |
| Signature | Token signature generated by issuer. |

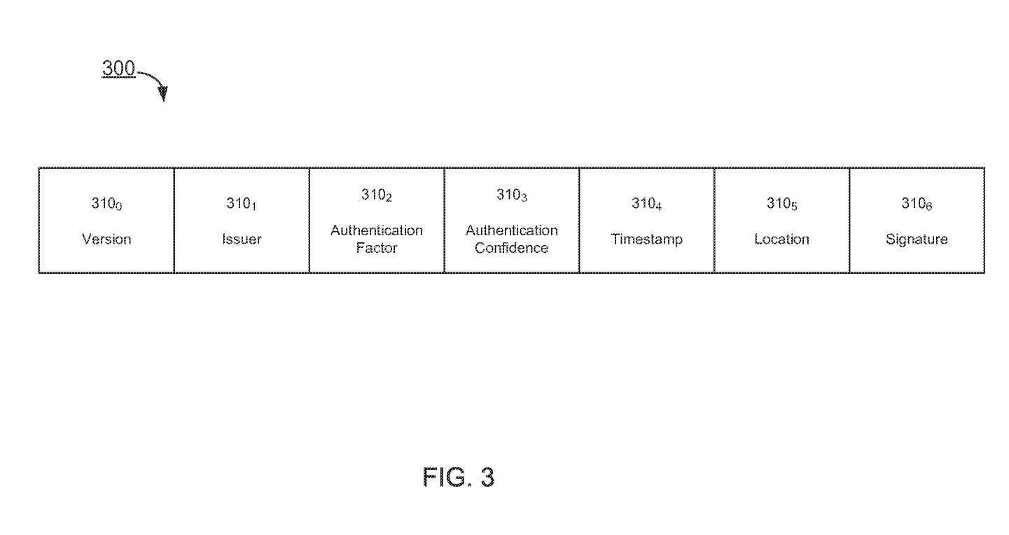

Note that these fields correspond to the illustration of a token shown in FIG. 3. In the embodiment shown in FIG. 3, a token 300 includes a plurality of fields 310₀-310₆. Understand while shown with a representative number of fields in the embodiment of FIG. 3, many variations and alternatives are possible. Understand also that a token including these or other fields may be protected prior to storage and/or communication, e.g., by way of one or more cryptographic measures. In the embodiment of FIG. 3, a version field 310₀ may be used to store a token format version number, such as a standard format of a given authentication system. An issuer field 310₁ may be used to store an identifier of an issuer of the token. A variety of information can be stored in this field such as the type of computing device, its trusted state (such as whether the device was in a trusted execution environment at the time of token creation or so forth). In some cases, this issuer field may provide an identity of device type (e.g., wearable, computer, or a cloud source). As an example, the issuer field may indicate whether the token was created by a wearable device or by an identity service itself and placed on the wearable device for later use. For example, a personal computer (PC) could use facial recognition to authenticate the user, generate a face recognition token, and place it into a wearable device for later use by the PC to authenticate the user again without re-verifying the face.

In the embodiment of FIG. 3, an authentication factor field 310₂ may store a value or indicator representing an authentication factor that created the token. Example authentication factors may include a biometric authentication factor and an on-person authentication factor, among other examples. An authentication confidence field 310₃ may store an indicator describing a given level of multiple levels of authentication confidence. Understand while the example of Table 1 shows four such levels, in different implementations a variety of different gradients of confidence of an individual factor can be expressed. For example, an on-body sensor may produce a “None” confidence when off the user and a “High” confidence when on the user. Instead a facial recognition factor may produce different confidence values depending upon matching confidence or whether extended anti-spoofing techniques were used.

Still with reference to FIG. 3, a timestamp field 310₄ may store a value describing or representing a timestamp when the token was created by the issuer. The timestamp allows multiple tokens to be bound together by policy. For example, an on-body token generated by a wearable device can be correlated with a facial recognition token to assert that the user was already wearing the wearable at the time of the face recognition and has not taken the wearable off since then.

In the embodiment of FIG. 3, a location field 310₅ may store a location indicator that describes or represents a location where an original authentication represented by the token occurred. Different levels of granularity of such location can be used. In some examples, rather than a particular geographic location (as determined, e.g., via a GPS sensor) the location field may indicate a trust level associated with the location at which the token was generated. In such instances, a higher level of confidence may be associated with a known, private location (such as a home or office), while a lower level of confidence may be associated with an unknown, public location such as an airport, shopping mall or so forth.

In the embodiment of FIG. 3, a signature field 310₆ may store a token signature generated by the issuer. In an embodiment, the signature may be generated according to a given cryptographic technique, such as a secure hash algorithm (SHA), as an example.

According to different authentication schemes based on different security policies, one or more of these fields may be used in determining whether to authenticate a user (and/or perform a re-authentication) based on values within the fields of one or more tokens and a particular security policy. As one example, a security policy may provide for enforcement such that a user may only be authenticated to an issuer device. In such example, an issuer field of a token may be analyzed to determine whether the issuer and the verifier are the same entity and if so to authenticate the user, and otherwise to prevent user authentication.

As another example, the issuer field may be associated with one of multiple identities of a particular computing system, such as a PC that is used in different environments by different users. In such case, a security policy may prevent a user authentication based on an issuer identity (and/or signature field) associated with a different user environment of the computing system.

As a still further example, information of a location field may be considered by some security policies. As one such example, a token may be trusted to enable a user authentication only if the location field of the token matches the location of the verifier device. Another example of a location-based security policy enforcement may be to prevent user authentication when a token was generated in an unknown location such as a public environment or so forth.

In different embodiments, the signature stored in the signature field may be an asymmetric cryptographic signature such as according to a Rivest Shamir Adleman (RSA) or elliptic curve cryptography (ECC) algorithm. In other cases the signature may be a pre-shared symmetric key. In some cases, a token may be associated with a message authentication code (MAC) to protect against tampering. Note that in cases where an issuer is also the authenticator (such in the context of a computer that generates an initial authentication token and later seeks to re-authenticate the user), the token may be keyed to a private key of the system. In other cases, such as a token generated by a wearable device, the token may be keyed by a pre-shared key between the issuer and verifier or an asymmetric key system may be used, as set up during a registration protocol between the wearable device and verifier.

Embodiments thus provide an ability to maintain confidence in an authentication that occurred in the past and reuse for new authentication requests. In addition, multiple authentication factors may be correlated in time and a given security policy can be applied to those factors, especially across multiple devices. Also tokens in accordance with an embodiment can convey information (including but not limited to time, location, type of authentication (such as password, face, etc., types of sensors used to determine on-body, etc.) to an authentication policy engine. Using such tokens enables a previous authentication to be combined with on-body sensors to detect separation, to re-use authentication from the past instead of re-authenticating the user.

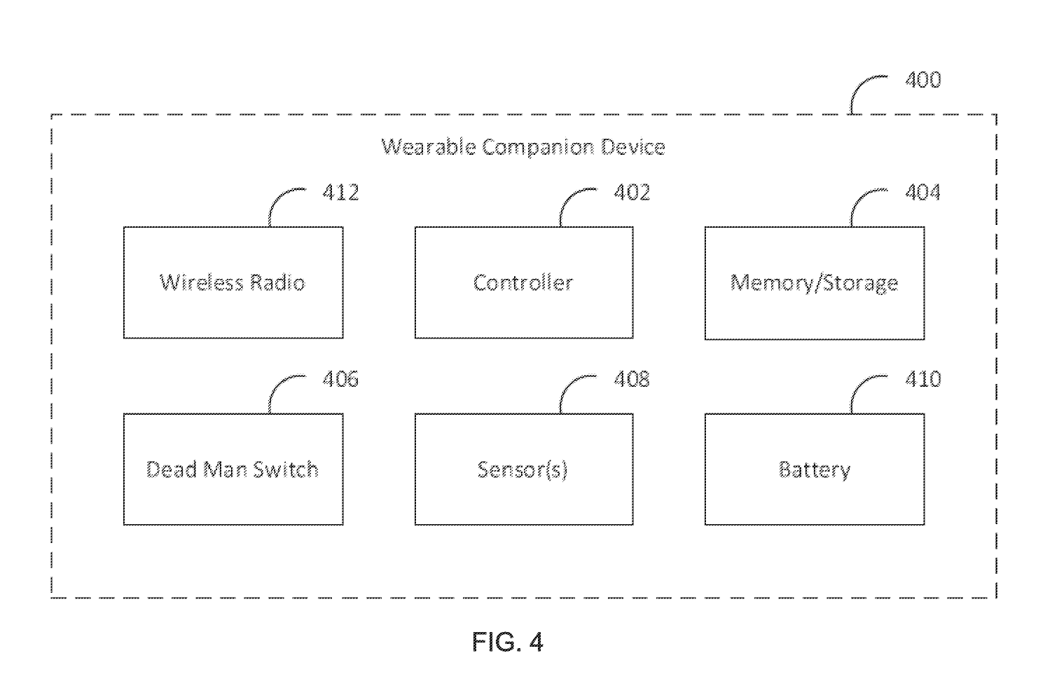

FIG. 4 is a block diagram of components included in an embodiment of the wearable device. In some embodiments, wearable device 400 may include a controller 402 (e.g., microcontroller), memory and/or storage 404 that may be a combination of volatile and non-volatile memory and storage, a dead man switch 406, one or more sensors 408 (e.g., accelerometer, temperature sensor, etc.), a power source 410 (e.g., a battery), and a wireless transceiver 412 (e.g., radio frequency) to communicate with the protected device(s). In some embodiments, there may be energy harvesting mechanisms to extend the life of power source 410. In some embodiments, one or more of the sensors 408 are capable of retrieving bio signatures to determine whether the user is in contact with the wearable device (e.g., a temperature sensor to detect body heat, a pulse detector, a capacitive touch detector, etc.).

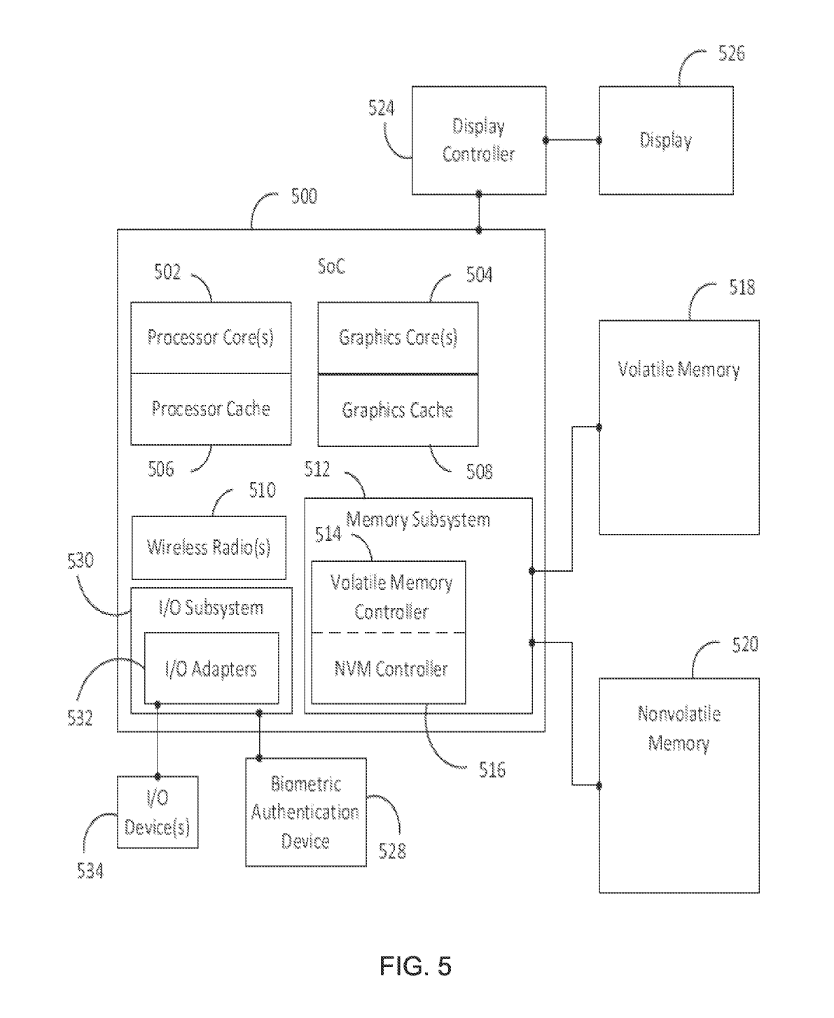

FIG. 5 illustrates an embodiment of a protected device incorporating wireless authentication technology that enables it to function as a primary protected device. The protected device, in some embodiments, comprises a system-on-a-chip (SoC) package 500 design that combines processor, graphics, memory, and I/O control logic into one SoC package. Thus, in FIG. 5, processor core(s) 502, the graphics core(s) 504, their respective caches (506 and 508) are all present in the package, along with memory subsystem 512 and I/O subsystem 530.

Although not shown, each processor core may internally include one or more instruction/data caches, execution units, prefetch buffers, instruction queues, branch address calculation units, instruction decoders, floating point units, retirement units, etc. Each core present is located on a processor semiconductor die. For each logic unit shown other than the core(s) 502 in the SoC package 500, the logic unit may be on the processor core(s) 502 semiconductor die in some embodiments or on another die in other embodiments. If a given logic unit is not on the same die as processor core(s) 502, that logic unit would be on a different semiconductor die, though in the same SoC package 500, which can include several dies communicatively coupled with each other in the package.

The SoC 500 also includes at least one lower-level processor cache 506. This may be a general-purpose cache capable of storing a significant amount of data retrieved from volatile memory 518 and/or non-volatile memory 520. In some embodiments, processor cache 506 may be shared among all cores 502. Alternatively, each core 502 may have its own dedicated processor cache 506.

Optionally, one or more graphics cores 504 are also included in SoC package 500 as well as a lower level graphics cache 508 which may store graphics-related data for the graphics core(s) 504 to work on. Graphics core(s) 504 may internally include one or more execution units and one or more instruction and data caches utilized to feed the execution units with information to process. Additionally the graphics core(s) 504 may contain other graphics logic units that are not shown in FIG. 5, such as one or more vertex processing units, rasterization units, media processing units, and codecs, among others. For simplicity, the specific logic within the graphics core(s) 504 is not shown. The graphics core and graphics cache may be involved in the authentication if images are involved in either the initial strong authentication of the user (e.g., pass-gestures or biometric scanning or imaging). Some embodiments, if not processing images during the authentication, may not need graphics capability unless it is necessary for some operation other than authentication. The graphics core(s) 504 provide image data to a protected device display. In some embodiments, the graphics core(s) 504 send data to a display controller 524, which in turn populates one or more displays 526 coupled to the system.

In FIG. 5, the SoC package 500 also includes a memory subsystem 512, including integrated volatile memory controller 514 providing access to volatile memory 518. Volatile memory controller 514 may receive a memory access request from a core and route that request to volatile memory 518. Likewise, non-volatile memory controller 516 may receive a memory access request from a core and route that request to non-volatile memory 520.

In some embodiments, an input/output (I/O) subsystem 530 is present in the system in FIG. 5 to communicate with I/O devices, such as I/O device(s) 534. The I/O subsystem 530 in FIG. 5 is integrated into the SoC package 500. Within the I/O subsystem 530, one or more I/O adapter(s) 532 are present to translate commands delivered in a host communication protocol from the processor core(s) 502 into compatible protocols for particular I/O devices. Some of the protocols may include Peripheral Component Interconnect (PCI)-Express (PCI-E), 3.0; Universal Serial Bus (USB), 3.0; Serial Advanced Technology Attachment (SATA), 3.0; Small Computer System Interface (SCSI), Ultra-640; and Institute of Electrical and Electronics Engineers (IEEE) 1594 “Firewire;” among others.

Additionally, one or more of the I/O adapters may translate to one or more wireless I/O protocols to communicate with wireless peripherals such as some embodiments of the wearable device. Some non-limiting examples of wireless protocols include those used in personal area networks, such as IEEE 802.15 and Bluetooth, 4.0; wireless local area network (LAN) protocols such as IEEE 802.11 and its derivatives; and cellular communication protocols such as those used in cellular telephony.

At least one authentication component 528 is coupled to the SoC. The authentication component 528 may be a palm vein reader, a fingerprint reader, an iris reader, an input for a password or a pass-gesture, or one or more other components for authenticating multiple factors.

In some embodiments, one or more wireless transceivers 510 are located on, or coupled to, the SoC. In some embodiments, some or all of the wireless transceivers 510 are located outside the SoC 500. The wireless transceivers may transmit and receive cellular signals such as LTE and 3G, Bluetooth signals, NFC signals, WiFi signals, and/or one or more other wireless and/or cellular protocols.

The following use cases illustrate example cases. Understand that many other use cases are possible, and the operations of the different use cases can in some cases be performed in different orders and/or combined to realize these and other use cases.

Use Case 1, passive wearable to device:

1. User puts on wearable

2. Wearable generates proximity token

3. User authenticates to phone/PC

4. Phone/PC places authentication token(s) in wearable database

5. User attempts to unlock phone/PC

6. Phone/PC retrieves tokens from wearable

7. Phone/PC grants access to user

Use Case 2, wearable loss of trust event:

1. User puts on wearable

2. Wearable generates proximity token

3. User authenticates to phone/PC

4. Phone/PC places authentication token(s) in wearable database

5. User attempts to unlock phone/PC

6. Phone/PC retrieves tokens from wearable

7. Phone/PC grants access to user

8. User removes wearable

9. Wearable notifies phone/PC of loss of trust event

10. Phone/PC protects local session until reauthentication of user

Use Case 3, wearable distance bounding:

1. User puts on wearable

2. Wearable generates proximity token

3. User authenticates to phone/PC

4. Phone/PC places authentication token(s) in wearable database

5. User attempts to unlock phone/PC

6. Phone/PC retrieves tokens from wearable

7. Phone/PC grants access to user

8. User moves wearable beyond policy-defined distance from phone/PC

9. Phone/PC protects local session

Use Case 4, active wearable to phone:

1. User puts on wearable

2. Wearable generates authentication token and proximity token

3. User attempts to unlock phone/PC

4. Phone/PC retrieves tokens from wearable

5. Phone/PC grants access to user

Use Case 5, phone to PC:

1. User has phone with them

2. User authenticates to PC

3. PC places authentication token(s) in phone UAS database

4. User attempts to unlock PC

5. PC retrieves tokens from phone

6. PC grants access to user

Use Case 6, cloud login:

1. User puts on wearable

2. Wearable generates proximity token

3. User authenticates to identify provider (IDP)

4. PC places IDP-generated authentication token(s) in wearable database

5. User attempts to access online resource

6. PC retrieves tokens from wearable

7. PC sends token information to cloud identity provider service

8. Identity provider service grants access to online resources

Use Case 7, wearable as key/badge replacement:

1. User puts on wearable

2. Wearable generates authentication token and proximity token

3. User attempts to open door/car/lock

4. Access control device retrieves tokens from wearable

5. Access control device grants access to user

Use Case 8, phone as intermediary:

1. User puts on wearable

2. Wearable generates authentication token and proximity token

3. User attempts to open door/car/lock

4. Access control device retrieves tokens from wearable via phone

5. Access control device grants access to user

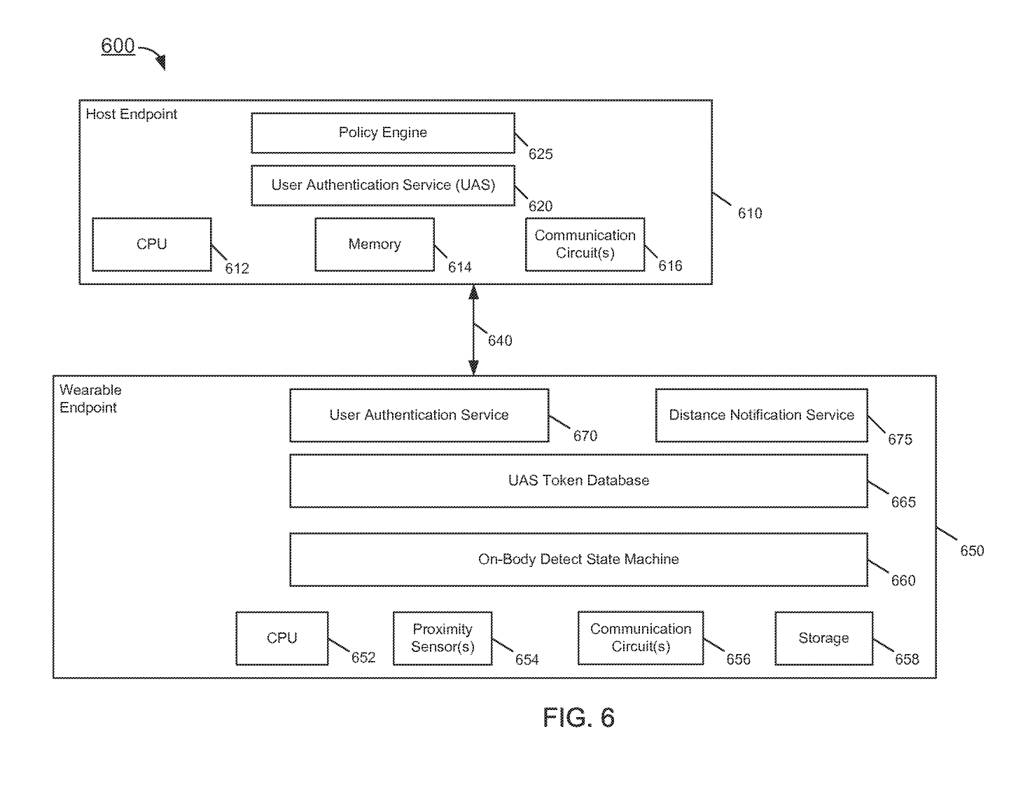

Referring now to FIG. 6, shown is a block diagram of a network architecture in accordance with an embodiment of the present invention. As shown in FIG. 6, architecture 600 includes multiple independent computing systems, namely a host endpoint 610 and a wearable endpoint 650 that couple via a channel 640, which in an embodiment may be a given short range wireless channel. Understand that these devices can take many different forms in different embodiments. As one non-limiting example, host endpoint 610 may be a computing device such as a client tablet computer, laptop computer, desktop computer or so forth, while wearable endpoint 650 may range from a relatively low complexity wearable device such as a pin, button or other very small form factor device to a larger device such as a smartphone or other portable computing device.

First with reference to host endpoint 610, various hardware is present. For purpose of broad illustration, a central processing unit (CPU) 612, a memory and one or more communication circuits 616 are shown. Of course in a particular host endpoint, many other hardware components and other circuitry may be present. In one embodiment, CPU 612 may be a multi-core processor or other system on chip (SoC). Memory 614 may include multiple independent memory and storage devices, including, for example, a dynamic random access memory (DRAM) and a non-volatile memory such as a flash memory, a solid state drive, a hard drive or so forth. Communication circuits 616 may include multiple wired and wireless communication circuits including short-range wireless devices such as a Bluetooth™ low energy transceiver, a near field communication device, a wide area wireless communication device such as a 4G cellular transceiver and so forth.

As further illustrated in FIG. 6, host endpoint 610 includes a user authentication service (UAS) 620 which may execute on CPU 612 and/or on a separate security device such as a secure element or logic, which may be within CPU 612 or implemented as a separate device. UAS 620 may perform the user-proximity based authentications described herein. To this end, UAS 620 may communicate with a policy engine 625, which also may be executed on the secure element, and which may determine whether to authenticate, not authenticate, de-authenticate and/or re-authenticate a user based on proximity to one or more devices (e.g., including user association with a wearable device and the wearable device being in close proximity to host endpoint 610).

As such, host endpoint 610 and wearable endpoint 650 may perform the authentications described herein when the devices are within a given short range wireless distance of each other, which may be determined based on received signal strength indicator (RSSI) distance bounding information.

Now with reference to wearable endpoint 650, the device includes various hardware, including a CPU 652, one or more proximity sensors 654, one or more communication circuits 656 and at least one storage 658. As described above, wearable endpoint 650 can take many different forms, in one embodiment it may be implemented as a single module, such as a small wearable button or so forth, including one or more semiconductor die. Further understand that while shown with the high level view in FIG. 6, a given wearable endpoint can include many other components.

Still referring to wearable endpoint 650, the device includes an on-body detect state machine 660, which in an embodiment may receive input from proximity sensors 654 and determine whether the wearable device is adapted to the user as described herein. In one embodiment, state machine 660 may execute on CPU 652, while in other cases the state machine may be an independent processing circuit. A UAS token database 665 is present and may be configured to store the various proximity and authentication tokens described herein, both generated in the wearable endpoint (for such devices capable of token generation) and received from a proximate computing system (such as a user's client system, or received from a remote authentication source). In an embodiment, database 665 may be stored in one or more of storages 658. In an embodiment, state machine 660 may cause one or more tokens to be deleted from database 665 responsive to detection that a user has removed or otherwise disassociated with the wearable endpoint.

As further illustrated, an instance of a user authentication service 670 may execute within wearable endpoint 650. In embodiments, this service can be executed on CPU 652 or a separate secure logic, either within the CPU or implemented as a separate device. Still further, a distance notification service 675 may execute within wearable endpoint 650. In an embodiment, service 675 may execute on CPU 652 and may be used to indicate when the wearable endpoint is within a threshold proximity (e.g., within a short-range wireless range, e.g., as determined by RSSI bounding information). Understand while shown at this high level in the embodiment of FIG. 6, many variations and alternatives are possible.

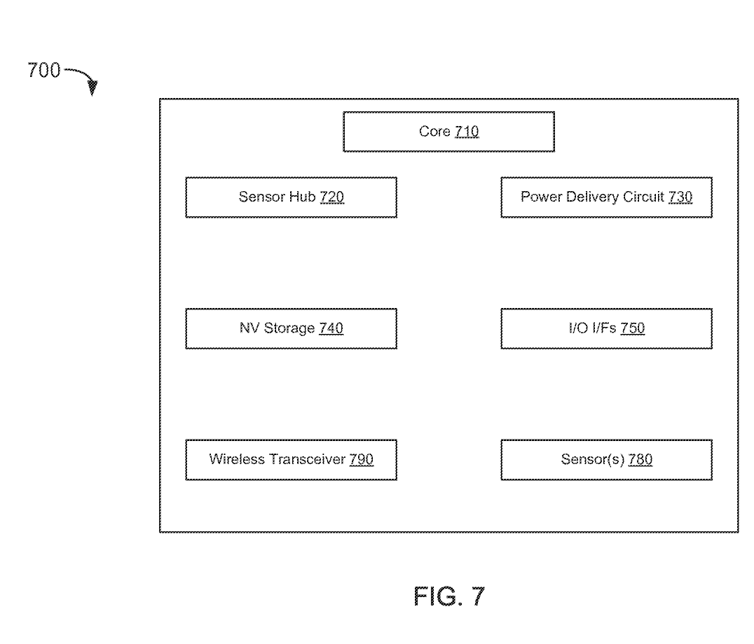

Referring now to FIG. 7, shown is a block diagram of a wearable module 700 in accordance with another embodiment. In one particular implementation, module 700 may be an Intel® Curie™ module that includes multiple components adapted within a single small module that can be implemented as all or part of a wearable device. As seen, module 700 includes a core 710 (of course in other embodiments more than one core may be present). Such core may be a relatively low complexity in-order core, such as based on an Intel Architecture® Quark™ design. Core 710 couples to various components including a sensor hub 720, which may be configured to interact with a plurality of sensors 780, such as one or more biometric, motion environmental or other sensors. A power delivery circuit 730 is present, along with a non-volatile storage 740. In an embodiment, this circuit may include a rechargeable battery and a recharging circuit, which may in one embodiment receive charging power wirelessly. One or more input/output (IO) interfaces 750, such as one or more interfaces compatible with one or more of USB/SPI/I²C/GPIO protocols, may be present. In addition, a wireless transceiver 790, which may be a Bluetooth™ low energy or other short-range wireless transceiver is present to enable wireless communications as described herein. Understand that in different implementations a wearable module can take many other forms.

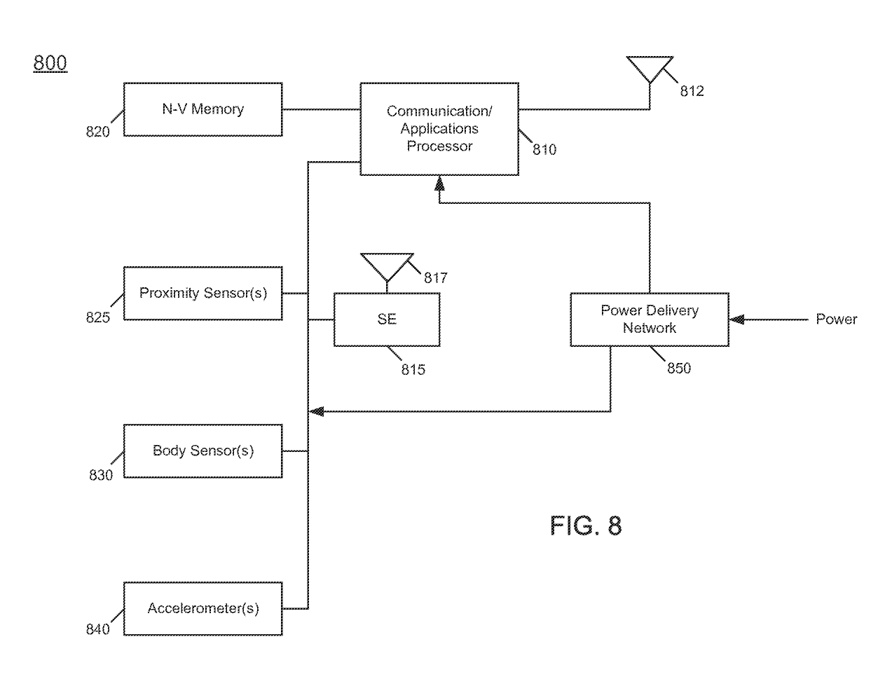

FIG. 8 illustrates another system 800 which may be a smartphone, wearable device or so forth to perform proximity-based authentications as described herein. As seen, system 800 includes a communications/applications processor 810, which may be a main processor of the system and which in turn may wirelessly communicate, e.g., according to at least a cellular communication protocol, via an antenna 812. Processor 810 further couples to a secure element 815 which in an embodiment can be implemented as a separate component, such as a hardened microcontroller unit or other circuit, and which may independently communicate via another antenna 817, in an embodiment. Secure element 815 may perform user proximity-based authentications. As seen, additional components of system 800 include a non-volatile memory 820, which may be used to store a database of tokens, as well as an authentication policy. One or more proximity sensors 825 may be configured to indicate proximity of a user. In addition, user adaptation can also be identified based at least in part on one or more body sensors 830, such as a heart rate sensor. In addition, system 800 includes one or more accelerometers 840, such as a multi-axis accelerator. In an embodiment, system 800 may be a rechargeable battery-powered device and thus a power delivery network 850 may include one or more voltage regulators, battery charger and so forth to receive power from a battery, as well as to provide a recharging current from an external connection, such as a wireless or USB connection to the battery. Understand while shown at this high level in the embodiment of FIG. 8, many variations and alternatives are possible.

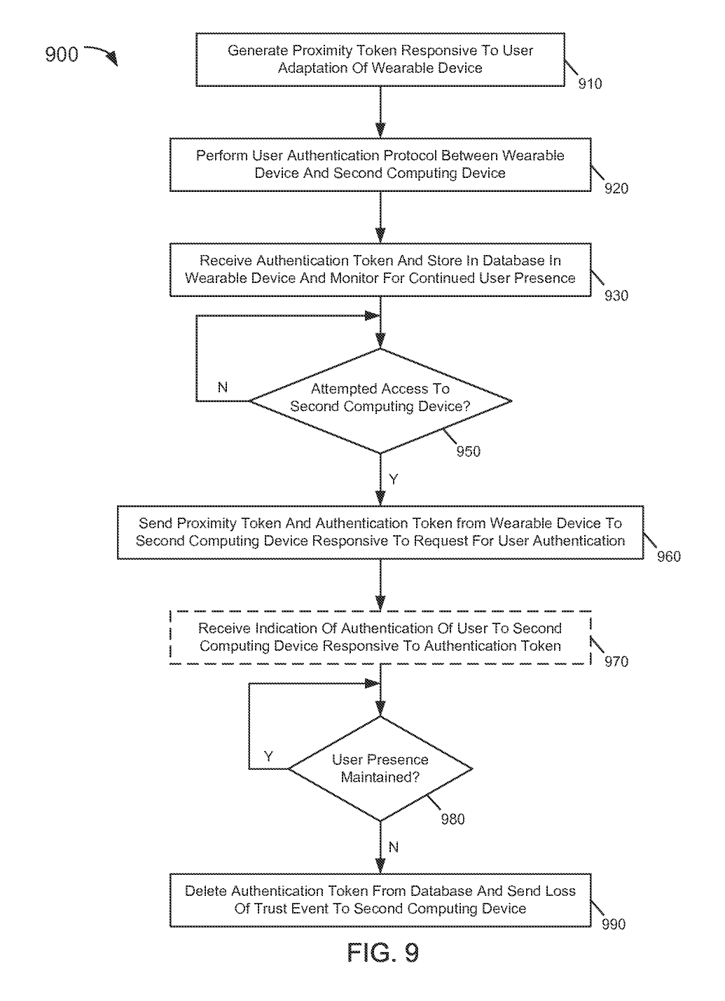

Referring now to FIG. 9, shown is a flow diagram of a method in accordance with an embodiment. In the embodiment of FIG. 9, various operations enable a proximity-based authentication to occur between a wearable device and another computing device. Method 900 begins by generating a proximity token responsive to user adaptation of the wearable device (block 910). In some cases, the wearable device itself may generate this proximity token, e.g., with a timestamp, and store it in a database of the wearable device. In a wearable device having insufficient computing capacity, this token may be received from another system. Thereafter, at block 920 a user authentication protocol is performed between the wearable device and a second computing device. As one example, this second computing device may be a work desktop computer of a user and to which the user has separately performed one or more factors of an authentication protocol.

Still with reference to FIG. 9, at block 930 the wearable device may receive an authentication token and store it in the database. This authentication token may be received from the second computing device and may include, for example, another timestamp associated with the time at which the user authenticated to the second computing device.

At this point, the wearable device may monitor for continued user presence. During such time it may be determined whether the user has attempted to access the second computing device (diamond 950). If so, both tokens (the authentication token and the proximity token) may be sent from the wearable device to the second computing device (block 960). In an embodiment, this communication may be responsive to a user authentication request received in the wearable device from the second computing device. Optionally, at block 970 the wearable device may receive an indication of authentication of the user to the second computing device. Next, at diamond 980 it is determined whether the user presence is maintained (such as whether the user has continued to associate with the wearable device). If not, control passes to block 990 where the tokens can be deleted from the database of the wearable device to prevent continued/further authentication of the user. As such, the wearable device may send a loss of trust event to the second computing device. Understand that depending on a given security policy, the second computing device may de-authenticate the user and similarly remove tokens. Or in other cases, the second computing device may simply prevent further protected session access until the user again returns in close proximity to the second computing device. In some cases, the security policy may further require the user again to adapt the wearable device before authenticating (or re-authenticating) to the second computing device. Understand while shown at this high level in the illustration of FIG. 9, many variations and alternatives are possible.

The following Examples pertain to further embodiments.

In Example 1, a first device comprises: a first logic to generate a first token when a user adapts the first device in approximate contact to the user, the first token including a first timestamp; a storage to store the first token and a second token, the second token obtained from an authenticator and associated with an authentication of the user to a second device, the second token including a second timestamp; and a communication module to communicate the first token and the second token to the second device to cause the second device to authenticate the user based on the first and second tokens.

In Example 2, the first device of Example 1 further comprises a controller to remove at least the first token when the first user is no longer in the approximate contact to the first device.

In Example 3, the first device of one or more of the above Examples further comprises a sensor to detect when the user is in the approximate contact to the first device.

In Example 4, the first token includes a plurality of fields including a first field to store the first timestamp and a second field to store a location identifier, the location identifier corresponding to a location at which the user adapted the first device in approximate contact to the user.

In Example 5, the second token includes a plurality of fields including a first field to store the second timestamp and a second field to store a location identifier associated with a location at which the user authenticated to the second device.

In Example 6, the second token further includes a third field to store an authentication factor indicator to indicate an authentication factor associated with the second token and a fourth field to store an authentication confidence indicator to indicate a level of authentication confidence associated with the authentication of the user by the authentication factor.

In Example 7, the storage of one or more of the above Examples is to store a third token, where the second token is associated with a first factor of the user authentication to the second device and the third token is associated with a second factor of the user authentication to the second device.

In Example 8, the authenticator comprises a remote authentication service.

In Example 9, the first device comprises a wearable module including at least one core, a power delivery circuit, at least one sensor, and where the communication module comprises a short-range wireless transceiver.

In Example 10, a method comprises: generating a second token having a second timestamp, responsive to authentication of a user to the computing system at a first time; sending the second token to a wearable device associated with the user to enable storage of the second token in the wearable device; receiving a first token and the second token from the wearable device and determining whether to authenticate the user to the computing system at a second time according to a security policy; and if the user is authenticated at the second time, granting access to a protected session within the computing system.

In Example 11, the method further comprises authenticating the user to the computing system at the first time according to a multi-factor authentication.

In Example 12, the method further comprises generating the second token responsive to a first authentication factor of the multi-factor authentication and storing an authentication indicator in a first field of the second token to indicate an authentication factor associated with the first authentication factor.

In Example 13, the method further comprises generating the second token further responsive to a second authentication factor of the multi-factor authentication and storing an authentication indicator in a second field of the second token to indicate an authentication factor associated with the second authentication factor.

In Example 14, the method further comprises sending the first token and the second token to a remote authentication server, and providing a grant indication received from the remote authentication server to the wearable device when the user is authenticated at the second time.

In Example 15, the remote authentication server is to enable the user to access a second computing system when the wearable device is adapted in close proximity to the user, based at least in part on the first token and the second token.

In Example 16, the method further comprises preventing continued access to the protected session responsive to receipt of a loss of trust indication from the wearable device.

In Example 17, the method further comprises sending the first token from the computing system to a second computing system to enable the second computing system to automatically authenticate the user when the wearable device is adapted in close proximity to the user and the wearable device is within a threshold proximity of the second computing system.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 18, a system comprises: a first processor to execute one or more applications, including a cellular telephone application; and a second processor comprising a secure logic to generate and store a first token in a non-volatile storage when a user is authenticated to the system and send the first token to a second device when the second device is adapted in approximate contact to the user and is in close proximity to the system, where the secure logic is to remove at least the first token from the non-volatile storage responsive to disassociation of the user from the second device.

In Example 19, the secure logic is to remove at least the first token responsive to a loss of trust assertion from the second device, the second device comprising a logic to determine the user disassociation based on which the loss of trust assertion is generated.

In Example 20, the secure logic is to communicate at least the first token to a second computing system to enable the second computing system to automatically authenticate the user when the second device is adapted in the approximate contact to the user and the second device is within a threshold proximity of the second computing system.

In Example 21, an apparatus comprises: means for generating a first token when a user adapts the apparatus in approximate contact to the user, the first token including a first timestamp; means for storing the first token and a second token, the second token obtained from an authenticator and associated with an authentication of the user to a second device, the second token including a second timestamp; and means for communicating the first token and the second token to the second device to cause the second device to authenticate the user based on the first and second tokens.

In Example 22, the apparatus further comprises a control means for removing at least the first token when the first user is no longer in the approximate contact to the apparatus.

In Example 23, the apparatus further comprises sensor means for detecting when the user is in the approximate contact to the apparatus.

In Example 24, the first token includes a plurality of fields including a first field to store the first timestamp and a second field to store a location identifier, the location identifier corresponding to a location at which the user adapted the apparatus in approximate contact to the user.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A first device comprising:
a first logic to generate a first token when a user adapts the first device in approximate contact to the user, the first token including a first timestamp;
a storage to store the first token and a second token, the second token obtained from an authenticator and associated with an authentication of the user to a second device, the second token including a second timestamp; and
a communication module to communicate the first token and the second token to the second device to cause the second device to authenticate the user based on the first and second tokens.

2. The first device of claim 1, further comprising a controller to remove at least the first token when the first user is no longer in the approximate contact to the first device.

3. The first device of claim 2, further comprising a sensor to detect when the user is in the approximate contact to the first device.

4. The first device of claim 1, wherein the first token includes a plurality of fields including a first field to store the first timestamp and a second field to store a location identifier, the location identifier corresponding to a location at which the user adapted the first device in approximate contact to the user.

5. The first device of claim 4, wherein the second token includes a plurality of fields including a first field to store the second timestamp and a second field to store a location identifier associated with a location at which the user authenticated to the second device.

6. The first device of claim 5, wherein the second token further includes a third field to store an authentication factor indicator to indicate an authentication factor associated with the second token and a fourth field to store an authentication confidence indicator to indicate a level of authentication confidence associated with the authentication of the user by the authentication factor.

7. The first device of claim 1, wherein the storage is to store a third token, wherein the second token is associated with a first factor of the user authentication to the second device and the third token is associated with a second factor of the user authentication to the second device.

8. The first device of claim 1, wherein the authenticator comprises a remote authentication service.

9. The first device of claim 1, wherein the first device comprises a wearable module including at least one core, a power delivery circuit, at least one sensor, and wherein the communication module comprises a short-range wireless transceiver.

10. At least one computer readable storage medium comprising instructions that when executed enable a computing system to:
generate a second token having a second timestamp, responsive to authentication of a user to the computing system at a first time;
send the second token to a wearable device associated with the user to enable storage of the second token in the wearable device;
receive a first token and the second token from the wearable device and determine whether to authenticate the user to the computing system at a second time according to a security policy; and
if the user is authenticated at the second time, grant access to a protected session within the computing system.

11. The at least one computer readable storage medium of claim 10, further comprising instructions that when executed enable the computing system to authenticate the user to the computing system at the first time according to a multi-factor authentication.

12. The at least one computer readable storage medium of claim 11, further comprising instructions that when executed enable the computing system to generate the second token responsive to a first authentication factor of the multi-factor authentication and store an authentication indicator in a first field of the second token to indicate an authentication factor associated with the first authentication factor.

13. The at least one computer readable storage medium of claim 12, further comprising instructions that when executed enable the computing system to generate the second token further responsive to a second authentication factor of the multi-factor authentication and store an authentication indicator in a second field of the second token to indicate an authentication factor associated with the second authentication factor.

14. The at least one computer readable storage medium of claim 10, further comprising instructions that when executed enable the computing system to send the first token and the second token to a remote authentication server, and provide a grant indication received from the remote authentication server to the wearable device when the user is authenticated at the second time.

15. The at least one computer readable storage medium of claim 14, wherein the remote authentication server is to enable the user to access a second computing system when the wearable device is adapted in close proximity to the user, based at least in part on the first token and the second token.

16. The at least one computer readable storage medium of claim 10, further comprising instructions that when executed enable the computing system to prevent continued access to the protected session responsive to receipt of a loss of trust indication from the wearable device.

17. The at least one computer readable storage medium of claim 10, further comprising instructions that when executed enable the computing system to send the first token from the computing system to a second computing system to enable the second computing system to automatically authenticate the user when the wearable device is adapted in close proximity to the user and the wearable device is within a threshold proximity of the second computing system.

18. A system comprising:
a first processor to execute one or more applications, including a cellular telephone application; and
a second processor comprising a secure logic to generate and store a first token in a non-volatile storage when a user is authenticated to the system and send the first token to a second device when the second device is adapted in approximate contact to the user and is in close proximity to the system, wherein the secure logic is to remove at least the first token from the non-volatile storage responsive to disassociation of the user from the second device.

19. The system of claim 18, wherein the secure logic is to remove at least the first token responsive to a loss of trust assertion from the second device, the second device comprising a logic to determine the user disassociation based on which the loss of trust assertion is generated.

20. The system of claim 19, wherein the secure logic is to communicate at least the first token to a second computing system to enable the second computing system to automatically authenticate the user when the second device is adapted in the approximate contact to the user and the second device is within a threshold proximity of the second computing system.
